(19) United States
(12) Patent Application Publication
(10) Pub. No.: US 2022/0342668 A1
(43) Pub. Date: Oct. 27, 2022

(54) System of Multiple Stacks in a Processor Devoid of an Effective Address Generator

(71) Applicant: Microchip Technology Inc., Chandler, AZ (US)

(72) Inventor: Christopher I. W. NORRIE, Castro Valley, CA (US)

(73) Assignee: Microchip Technology Inc., Chandler, AZ (US)

(21) Appl. No.: 17/468,574

(22) Filed: Sep. 7, 2021

Related U.S. Application Data
(60) Provisional application No. 63/180,601, filed on Apr. 27, 2021.

(51) Int. Cl. G06F 9/30; G06F 9/38

(52) U.S. Cl. CPC G06F 9/30134; G06F 9/3806

(57) ABSTRACT

In one implementation devoid of an effective address generator a method of call operation comprises pushing one or more parameters onto a first stack, pushing the contents of one or more registers onto a second stack, popping off the first stack one or more of the parameters into one or more of the registers whose contents were pushed onto the second stack, performing register to register operations on the one or more registers whose contents were pushed onto the second stack with a result of the register to register operations being stored in a result register, the result register being one of the one or more registers whose contents were pushed onto the second stack, popping off the second stack the contents of all the one or more registers into their respective registers from which they came, and returning control to an instruction following the call.

### RELATED APPLICATION

This patent application claims priority of pending U.S. Application Ser. No. 63/180,601 filed Apr. 27, 2021 by the same inventor titled “System of Multiple Stacks in a Processor Devoid of an Effective Address Generator” which is hereby incorporated herein by reference.

### FIELD

The present method and apparatus pertain to a processor devoid of an effective address generator. More particularly, the present method and apparatus relates to a system of multiple stacks in a processor devoid of an effective address generator.

### BACKGROUND

Modern microprocessors have address generators so that, for example, the central processing unit (CPU) can interact (e.g. read, write) with memory. These are called Effective Address Generators (EAG). By the nature of their tasks they are large integrated circuit wise, complex, consume large amounts of power, and because of their flexibility in addressing modes are unable to keep up with a dedicated high-speed processor such as a vector processing unit.

The following is an example piece of pseudo code that demonstrates a subroutine performing “(A+B)*A/B”, where A and B are passed as parameters to a subroutine. This first case (Case 1) performs the operation on a processor that has an EAG. The first case (Case 1) further shows how the memory address is generated by an EAG.

Case 1: processor with EAG

set up a stack segment, ss
initialize the stack registers - base, limit, stack pointer(sp)
set up a data segment, ds
set up a base register, r15, for local variables
:

| | |
|---|---|
| push parameter 1 | push 1st parameter to parameter stack |
| push parameter 2 | push 2nd parameter to parameter stack |

call subroutine

| MOV | [r15]+0,r0 | save r0 to local mem | EAG: ds + r15 + (0*0) + 0 |
|---|---|---|---|
| MOV | [r15]+4,r1 | save r1 to local mem | EAG: ds + r15 + (0*0) + 4 |
| POP | r0 | pop 1st parameter | EAG: ss + sp + (0*0) + 0 |
| POP | r1 | pop 2nd parameter | EAG: ss + sp + (0*0) + 0 |
| MOV | [r15]+8, r0 | copy 1st parameter to local mem | EAG: ds + r15 + (0*0) + 8 |
| MOV | [r15]+12,r1 | copy 2nd parameter to local mem | EAG: ds + r15 + (0*0) + 12 |
| ADD | r0,r1 | perform (1st + 2nd) * 1st / 3rd parameters | |
| MUL | r0,[r15]+8 | | |
| DIV | r0,[r15]+12 | | |
| PUSH | r0 | push result to stack | EAG: ss + sp + (0*0) + 0 |
| MOV | r0,[r15]+0 | restore r0 from local mem | EAG: ds + r15 + (0*0) + 0 |
| MOV | r1,[r15]+4 | restore r1 from local mem | EAG: ds + r15 + (0*0) + 4 |

| | |
|---|---|
| RTRN | subroutine complete |

POP subroutine result pop subroutine-result from stack
do something with result

In this first case (Case 1), the memory address is generated by a 4-port EAG, similar in nature to that in an Intel® x86 processor. This EAG sums 4 terms:
1. A segment address (in this example there is a data segment and a stack segment).
2. A base register that provides an offset into the segment and provides a local variable area.
3. An index register that can be scaled (multiplied) by 0, 1, 2, 4, or 8 and makes accessing of arrays simple. (This is shown as (0*0) in this example since no arrays are being accessed so no index is required.
4. A displacement, that provides the offset in the local variable space where each particular variable is located.

In this example, we are assuming, just for the sake of illustration that we are dealing with 32 bit register and memory contents, that is 4 bytes (4 bytes*8 bits/byte=32 bits). Thus, the address and register increments of +0, +4, +8, +12 for 4 consecutive memory/register locations. The EAG: entries illustrate how the effective address is arrived at.

For example, the entry:

EAG: ds+r15+(0*0)+4

The first entry ds is the data segment that was set up before entering the subroutine.
The second entry r15 was set up as a base register for local variables.
The third entry (0*0) is index register scaling which an EAG provides which in this case is not used and so the additional memory offset=(0*0)=0.
The fourth entry 4 is a direct offset from the other addresses calculation.
So, for example if ds=0xA2440, r15=0x4588 then the EAG=0xA2440+0x4588+(0*0)+4=0xA69CC

The instruction:

| | | |
|---|---|---|
| MOV | [r15]+8, r0 | copy 1st parameter to local mem |

Is read thusly, get the contents of register r0 and copy it to data segment location in memory r15+8, where r15 was previously set up as a base register for local variables and where +8 is the offset of 8 bytes from the r15 base memory location.

Even the push and pop to/from the stack uses the EAG.

The instruction:

| | | | |
|---|---|---|---|
| POP | r0 | pop 1st parameter | EAG: ss + sp + (0*0) + 0 |

Is read thusly, pop r0 (which in this example has the 1st parameter) off the stack, with the stack address being determined by the stack segment ss being added to the stack pointer sp and the scaling factor of (0*0), and the direct offset of 0.
So for example if ss=0xebefcf, and sp=0xf then r0 would have an address of 0xebefcf+0xf+0+0=0xebefde

As can be seen in this simple example the EAG's address calculation involves four variables.

In brief summary, EAG features include:

Can be used to push parameters to a function.
Can be used to save and restore registers.
Can provide working area of memory for local variables in a function.
Provides access to arrays.
Provides generic memory processing.
Provides complex memory addressing.
Allows for sophisticated memory protection.

In brief summary, EAG costs include:

Very complex component of a processing system. Requires a complex adder with many ports (such as 4), some requiring access to the general purpose register set, some requiring pre-scaling before the addition, some requiring highly specialized registers for access control, and some requiring direct access to instruction fields. It is generally a very cycle-time sensitive component, making it difficult to meet cycle time, since it is in the memory access path, it has non-trivial bypass paths and pipeline interlocks to resolve register hazards, and includes memory access protection provision. Its existence affects the structure of most instructions in the processor instruction set. It is a major component of the functional architecture and a large and complex part of the design.

Thus, an effective address generator is a complex, complicated, power hungry, large piece of circuitry that may be effective for general purpose processors, but is often an unnecessary overkill for specialized processors such as vector processors or machine learning processors. Accordingly, an effective address generator does not provide optimum control.

### BRIEF SUMMARY

A vector processor apparatus comprises a first stack, the first stack for pushing of parameters, and a second stack, the second stack for saving and restoring of registers and wherein the first stack and the second stack can be in simultaneous operation.

In one example, a processor apparatus comprises a first stack, the first stack for pushing of parameters, and a second stack, the second stack for saving and restoring of registers and wherein the first stack and the second stack can be in simultaneous operation, and wherein the vector processor is devoid of an effective address generator.

### BRIEF DESCRIPTION OF THE DRAWINGS

The techniques disclosed are illustrated by way of examples and not limitations in the figures of the accompanying drawings. Same numbered items are not necessarily alike.

The accompanying Figures illustrate various non-exclusive examples of the techniques disclosed.

FIG. 1 illustrates an example of a call operation.

FIG. 2 illustrates an example of a call operation pushing a result register.

FIG. 3 illustrates an example of a call operation pushing and popping directly.

FIG. 4 illustrates an example of where register to register operations are performed in a set of one or more parallel operations.

FIG. 5 illustrates an example of series and parallel operations.

FIG. 6 illustrates an example of the first stack and the second stack in substantially simultaneous operation.

FIG. 7 illustrates an example of a set of one or more serial operations.

FIG. 8 illustrates an example of another invocation of the call operation.

FIG. 9 illustrates an example flowchart of a call operation.

FIG. 10 illustrates an example block diagram of a vector processor apparatus.

FIG. 11 illustrates an example block diagram of a vector processor apparatus where the vector arithmetic unit is configured for communication with the shared memory portion of the memory.

FIG. 12 illustrates an example of a scattered arrangement of registers.

FIG. 13 illustrates an example of a clustered arrangement of registers.

FIG. 14 illustrates an example of using a dedicated memory portion or a shared memory portion.

FIG. 15 illustrates an example of a flash controller.

FIG. 16 illustrates an example of a flash controller using a dedicated memory portion or a shared memory portion.

FIG. 17 illustrates an example flowchart of a flash controller vector processor call operation.

FIG. 18 illustrates an example flowchart of a flash controller vector processor including a parameter stack specialized instruction.

FIG. 19 illustrates an example flowchart of a flash controller vector processor including a register stack specialized instruction.

FIG. 20 illustrates an example flowchart of a flash controller vector processor without a use of an effective address generator.

FIG. 21 illustrates an example where invocation of a parameter stack specialized instruction and invocation of a register stack specialized instruction are independent of each other in time.

FIG. 22 illustrates an example where a first plurality of invocations of a parameter stack specialized instruction and a second plurality of invocations of a register stack specialized instruction are independent of a state of the contents of a parameter stack and are independent of a state of a contents of a register stack.

FIG. 23 illustrates an example where a simultaneous operation of saving or restoring the plurality of parameter stack contents and a simultaneous operation of saving or restoring the plurality of register stack contents are without a use of an effective address generator.

### DETAILED DESCRIPTION

A System of Multiple Stacks in a Processor

As was disclosed in the Background an EAG is unnecessarily complex and expensive for processors such as a vector processor or machine learning processor. Using the techniques disclosed herein, a system of multiple stacks in a processor devoid of an EAG can keep up with a high speed processor such as a vector processor.

Case 1 in the background illustrated an example using an EAG.

The following is an example, Case 2, of a piece of pseudo code that demonstrates a subroutine performing “(A+B)*A/B”, where A and B are passed as parameters to a subroutine. This second case, Case 2, performs the operation on a processor that has no EAG. The second case shows how the memory address is generated without an EAG and how the two stacks facilitate this.

CASE 2: Processor with NO EAG

initialize the parameter-stack registers - base, limit, stack pointer(sp)
initialize the register-stack registers - base, limit, stack pointer(rp)
:

| | | |
|---|---|---|
| PUSH parameter 1 | push 1st parameter to parameter stack | mem-addr is sp |
| PUSH parameter 2 | push 2nd parameter to parameter stack | mem-addr is sp |

CALL subroutine

| SAVE | r0,r3 | save r0 through r3 to register stack | mem-addr is rp |
|---|---|---|---|
| POP | r0 | pop 1st parameter from parameter stack | mem-addr is sp |
| POP | r1 | pop 2nd parameter from parameter stack | mem-addr is sp |
| MOV | r2 r0 | copy 1st parameter to r2 | |
| MOV | r3 r1 | copy 2nd parameter to r3 | |
| ADD | r0,r1 | perform (1st + 2nd) * 1st / 3rd parameters | |
| MUL | r0,r2 | | |
| DIV | r0,r3 | | |
| PUSH | r0 | push result to parameter stack | mem-addr is sp |
| RSTR | r0,r3 | restore r0 through r3 from register stack | mem-addr is rp |

| | |
|---|---|
| RTRN | subroutine complete |

POP subroutine result pop result from stack from parameter stack mem-addr is sp
do something with result

In this second case (Case 2), the memory address is either the parameter-stack-pointer (sp) or the register-stack-pointer (rp). Since this second case (Case 2) has no EAG, it is not particularly adept for accessing arrays, however, if array processing is performed by a co-processor, such as a vector processor or machine-learning processor, this capability is not needed and the dual stack leads to a preferred (and much simpler in gate count, much less in power, and faster in speed) solution compared to an EAG. Additionally, the dual stack approach simplifies the instruction set since instructions do not need to provide EAG parameters.

In brief summary, Dual stack features include:

Specifically pushes parameters to a function.
Specifically saves and restores registers.
Eliminates the need to provide working area of memory for saved local variables in a function since the registers can be saved and restored and therefore used instead of memory.
Access to arrays is not required since this is offloaded to a coprocessor.
Generic memory processing is not required since this is offloaded to a coprocessor.
Complex memory addressing is not required since this is offloaded to a coprocessor.
Complete yet very simple memory protection.

In brief summary, Dual stack costs include:

A single (per stack) top-of-stack register replaces the entire adder of an EAG, along with all the EAG's complex ports, pre-scaling, register hazard resolution, etc. The entire memory protection mechanisms of the EAG are replaced in the dual stack with a very simple base and limit check. Each stack has corresponding push and pop type instructions rather than nearly all instructions, (like in an EAG) having to specify their address generation properties and modes. The simplicity of the dual stack techniques disclosed leads to circuits that are extremely small in size and power, and easily meet processor cycle times.

The dual stack approach is a very specific technique dedicated to memory access control and eliminates the EAG for processors that can offload certain functions that would otherwise be aided by an EAG to a coprocessor (e.g., a vector processor, a machine learning processor, etc.) instead.

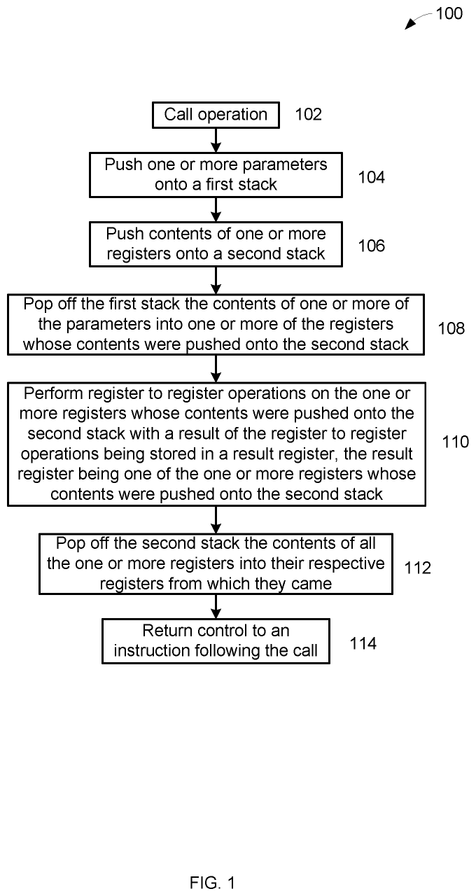

FIG. 1 illustrates, generally at 100, an example of a call operation. At 102 the call operation 100 starts and proceeds to 104 where one or more parameters are pushed onto a first stack. The call operation 100 then proceeds to 106 where contents of one or more registers are pushed onto a second stack, which is a different stack than the first stack. The call operation 100 then proceeds to 108 where it pops off the first stack the contents of one or more of the parameters into one or more of the registers whose contents were pushed onto the second stack in 106. The call operation 100 then proceeds to 110 where it performs register to register operations on the one or more registers whose contents were pushed onto the second stack with a result of the register to register operations being stored in a result register, the result register being one of the registers whose contents were pushed onto the second stack. The call operation 100 then proceeds to 112 where it pops off the second stack the contents of all the one or more registers into their respective registers from which they came. The call operation 100 then proceeds to 114 where it returns control to an instruction following the call.

While the operations are shown in FIG. 1 in a sequence, for example, operation at 104 before 106, the operation is not so limited, and for example operation 106 may precede 104 or occur at the same time.

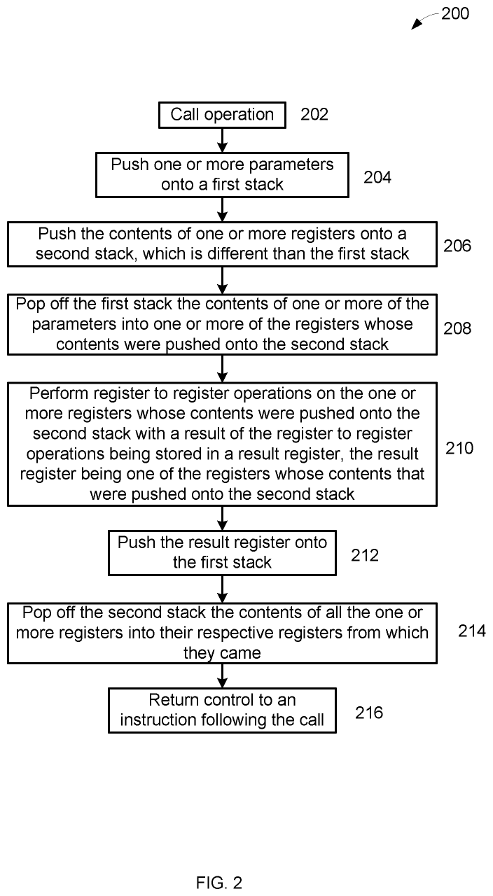

FIG. 2 illustrates, generally at 200, an example of a call operation pushing a result register. At 202 the call operation 200 starts and proceeds to 204 where one or more parameters are pushed onto a first stack. The call operation 200 then proceeds to 206 where the contents of one or more registers are pushed onto a second stack, which is a different stack than the first stack. The call operation 200 then proceeds to 208 where it pops off the first stack one or more of the parameters into one or more of the registers whose contents were pushed onto the second stack. The call operation 200 then proceeds to 210 where it performs register to register operations on the one or more registers whose contents were pushed onto the second stack with a result of the register to register operations being stored in a result register, the result register being one registers whose contents were pushed onto the second stack. The call operation 200 then proceeds to 212 where it pushes the result register onto the first stack. The call operation 200 then proceeds to 214 where it pops off the second stack the contents of all the one or more registers from the second stack into their respective registers from which they came. The call operation 200 then proceeds to 216 where it returns control to an instruction following the call.

While the operations are shown in FIG. 2 in a sequence, for example, operation at 204 before 206, the operation is not so limited, and for example operation 206 may precede 204 or occur at the same time, or they may overlap in time.

In FIG. 2 operation 212 of pushing the result register onto the first stack allows for another operation to simply pop the contents of the first stack and retrieve the result of the register to register operations, for example from the operation denoted in FIG. 2 at 210. That is when control is returned to an instruction following the call, as in operation 216 in FIG. 2, the calling program knows that the top entry on the parameter stack holds a result. Therefore there is no need for an effective address generator to point to the result.

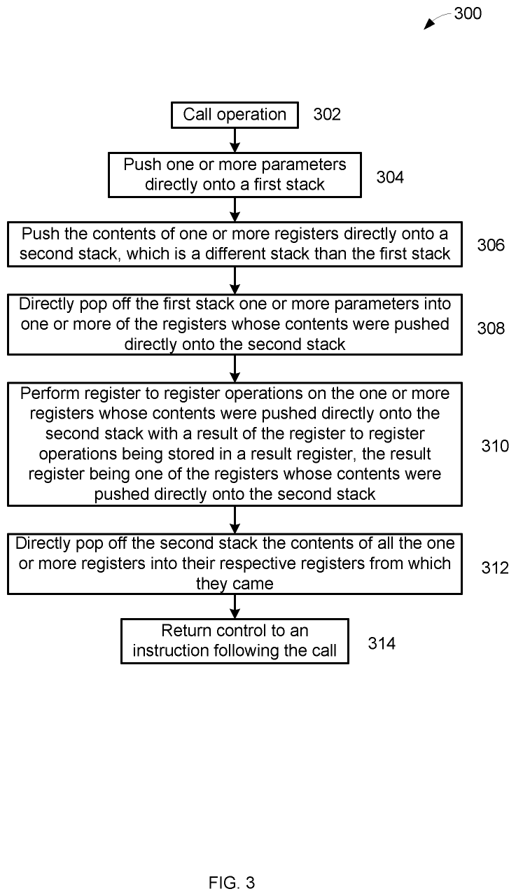

FIG. 3 illustrates, generally at 300, an example of a call operation pushing and popping directly. Pushing and popping directly refers to the operation proceeding without utilizing an intermediate location to store or temporarily store the contents before it reaches a final destination. That is, for example, a direct push of the contents of A to B can be diagramed as:

A→B, where there is no intermediary location.
The following example is not a direct push of the contents of A to B:
A→X→B, because X is an intermediary location where the contents of A are stored before they reach the destination B. At 302 the call operation 300 starts and proceeds to 304 where one or more parameters are pushed directly onto a first stack. The call operation 300 then proceeds to 306 where the contents of one or more registers are pushed directly onto a second stack, which is a different stack than the first stack. The call operation 300 then proceeds to 308 where it directly pops off the first stack one or more of the parameters into one or more of the registers whose contents were pushed directly onto the second stack at 306. The call operation 300 then proceeds to 310 where it performs register to register operations on the one or more registers whose contents were pushed directly onto the second stack with a result of the register to register operations being stored in a result register, the result register being one of the registers whose contents were pushed directly onto the second stack at 306. The call operation 300 then proceeds to 312 where it directly pops off the second stack the contents of all the one or more registers into their respective registers from which they came. The call operation 300 then proceeds to 314 where it returns control to an instruction following the call.

While the operations are shown in FIG. 3 in a sequence, for example, operation at 304 before 306, the operation is not so limited, and for example operation 306 may precede 304 or occur at the same time, or they may overlap in time.

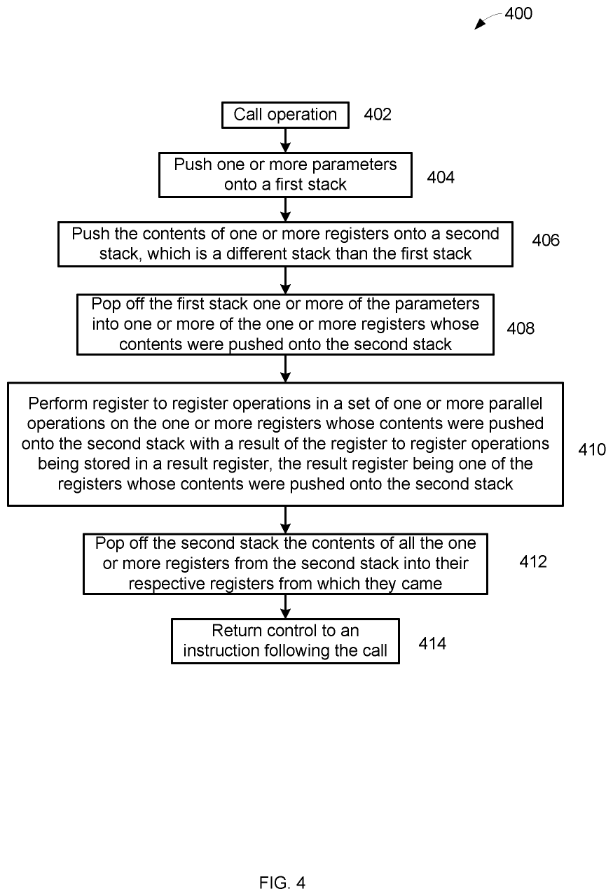

FIG. 4 illustrates, generally at 400, an example of register to register operations performed in a set of one or more parallel operations. At 402 the call operation 400 starts and proceeds to 404 where one or more parameters are pushed onto a first stack. The call operation 400 then proceeds to 406 where the contents of one or more registers are pushed onto a second stack, which is a different stack than the first stack. The call operation 400 then proceeds to 408 where it pops off the first stack one or more of the parameters of 404 into one or more of the one or more registers whose contents were pushed onto the second stack. The call operation 400 then proceeds to 410 where it performs register to register operations in a set of one or more parallel operations on the one or more registers whose contents were pushed onto the second stack with a result of the register to register operations being stored in a result register, the result register being one of the registers whose contents were pushed onto the second stack. The call operation 400 then proceeds to 412 where it pops off the second stack the contents of all the one or more registers from the second stack into their respective registers from which they came. The call operation 400 then proceeds to 414 where it returns control to an instruction following the call.

While the operations are shown in FIG. 4 in a sequence, for example, operation at 404 before 406, the operation is not so limited, and for example operation 406 may precede 404 or occur at the same time, or they may overlap in time.

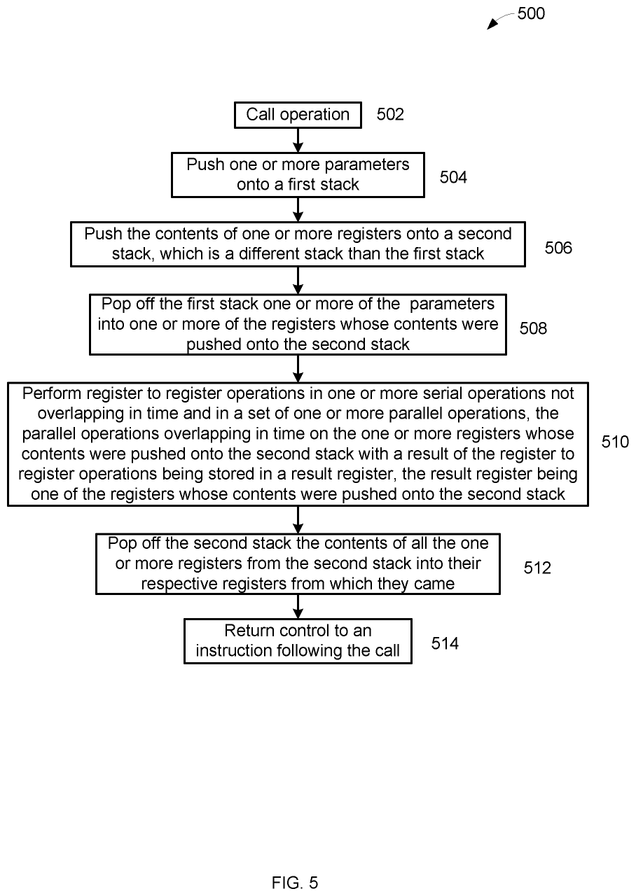

FIG. 5 illustrates, generally at 500, an example of series operations and parallel operations. At 502 the call operation 500 starts and proceeds to 504 where one or more parameters are pushed onto a first stack. The call operation 500 then proceeds to 506 where the contents of one or more registers are pushed onto a second stack, which is a different stack than the first stack. The call operation 500 then proceeds to 508 where it pops off the first stack one or more of the parameters of 504 into one or more of the registers whose contents were pushed onto the second stack. The call operation then proceeds to 510 where it performs register to register operations in one or more serial operations not overlapping in time and in a set of one or more parallel operations, the parallel operations overlapping in time, on the one or more registers whose contents were pushed onto the second stack with a result of the register to register operations being stored in a result register, the result register being one of the registers whose contents were pushed onto the second stack. The call operation 500 then proceeds to 512 where it pops off the second stack the contents of all the one or more registers from the second stack into their respective registers from which they came. The call operation 500 then proceeds to 514 where it returns control to an instruction following the call.

While the operations are shown in FIG. 5 in a sequence, for example, operation at 504 before 506, the operation is not so limited, and for example operation 506 may precede 504 or occur at the same time, or they may overlap in time.

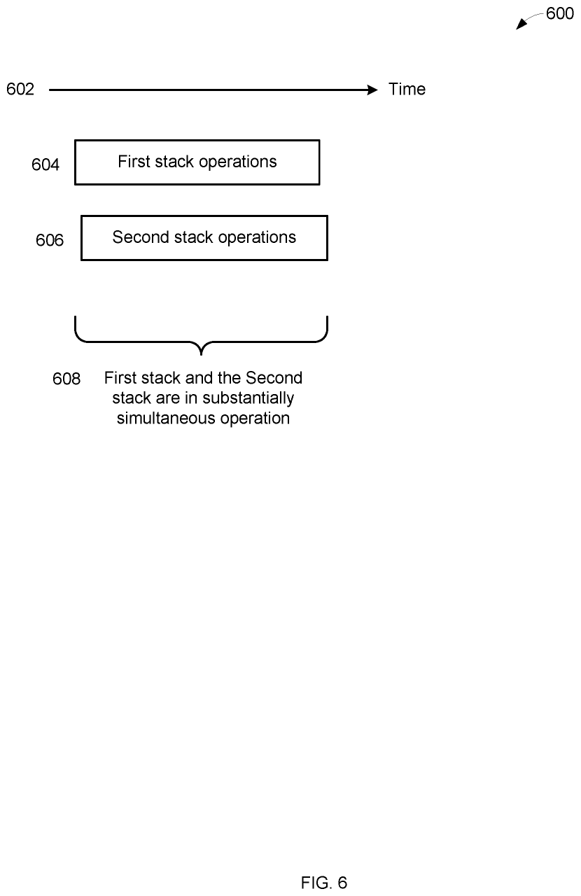

FIG. 6 illustrates, generally at 600, an example of the first stack and the second stack being in substantially simultaneous operation. At 602 is a representative timeline denoted Time with the earlier in time arrow at the end proximate to the 602 marker. The later in time being near the arrow near Time. At 604 is a representation of First stack operations. At 606 is a representation of Second stack operations. At 608 is denoted that First stack and the Second stack are in substantially simultaneous operation, i.e. the parallel operations overlap in time.

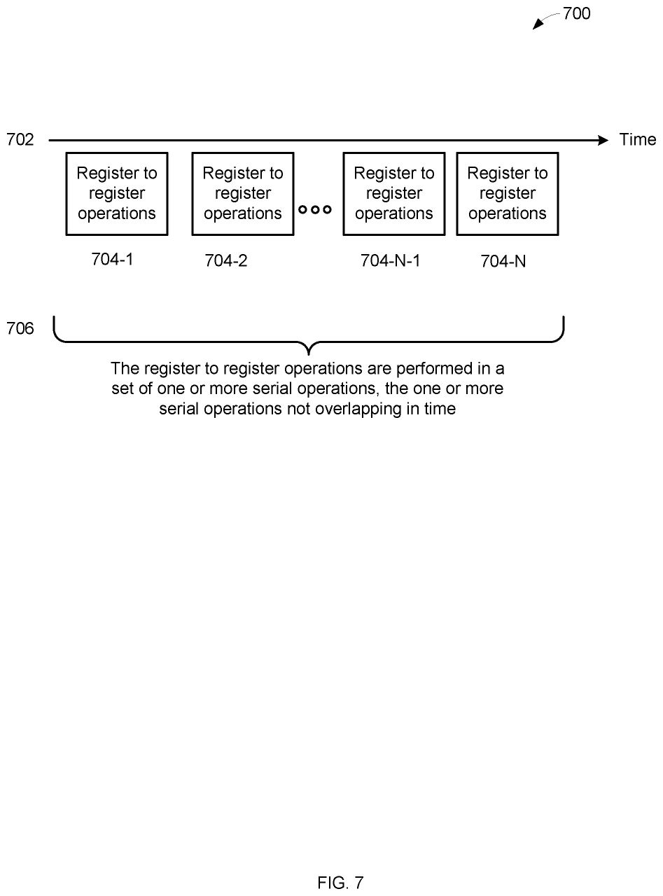

FIG. 7 illustrates, generally at 700, an example of a set of one or more serial operations. At 702 is a representative timeline denoted Time with the earlier in time arrow at the end proximate to the 702 marker. The later in time being near the arrow near Time. At 704-1, 704-2, . . . , 704-N-1, 704-N is a representation of register to register operations where N is an integer greater than 1. At 706 is denoted that the register to register operations are performed in a set of one or more serial operations, the one or more serial operations not overlapping in time.

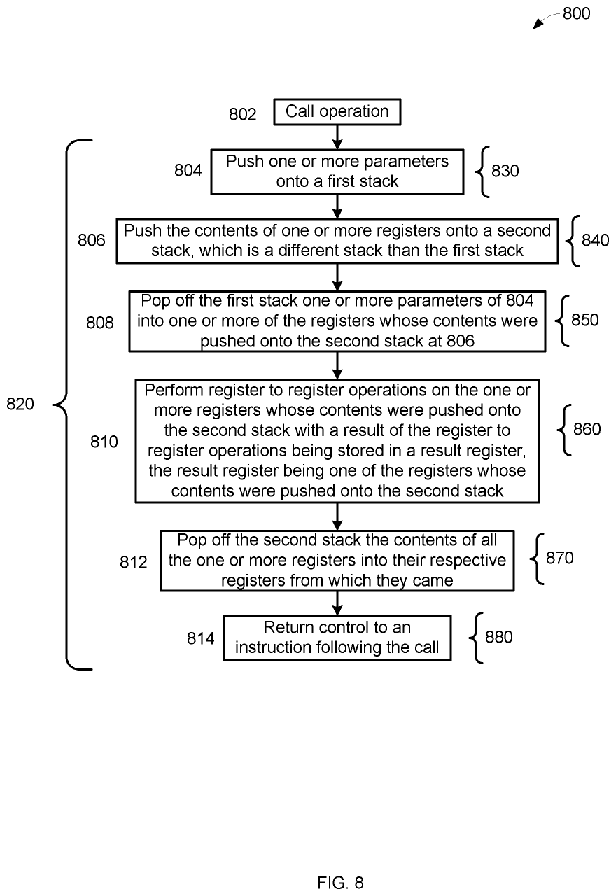

FIG. 8 illustrates, generally at 800, an example of another invocation of the call operation which may be performed during a previous invocation of the call operation. At 802 the call operation 800 starts and proceeds to 804 where one or more parameters are pushed onto a first stack. The call operation 800 then proceeds to 806 where the contents of one or more registers are pushed onto a second stack, which is a different stack than the first stack. The call operation 800 then proceeds to 808 where it pops off the first stack one or more of the parameters of 804 into one or more of the registers whose contents were pushed onto the second stack at 806. The call operation 800 then proceeds to 810 where it performs register to register operations on the one or more registers whose contents were pushed onto the second stack with a result of the register to register operations being stored in a result register, the result register being one of the registers whose contents were pushed onto the second stack. The call operation 800 then proceeds to 812 where it pops off the second stack the contents of all the one or more registers into their respective registers from which they came. The call operation then proceeds to 814 where it returns control to an instruction following the call.

This sequence 804, 806, 808, 810, 812, and 814 is denoted as 820.

830, 840, 850, 860, 870, and 880 are each representative of the sequence denoted at 820. That is, for example, 850 represents the 820 operations (804 through 814). What 830, 840, 850, 860, 870, and 880 are also indicating is that these 820 operations (804 through 814) can be performed at any of the places indicated. For example, at 804 another invocation of a call operation can be performed as indicated by 830. This shows that a currently executing call operation can be interrupted by, or call, another call operation (invocation) at any of the 804 through 814 steps respectively shown as 830 through 880.

While the operations are shown in FIG. 8 in a sequence, for example, operation at 804 before 806, the operation is not so limited, and for example operation 806 may precede 804 or occur at the same time, or they may overlap in time.

While FIG. 8 illustrates a call operation being interrupted by, or calling, another call operation, that is two levels deep, the technique is not so limited and levels greater than two can be achieved (nested). That is, 3 or more levels deep of call operations are possible. That is, for each invocation of a Call operation the nesting level increases and as each invocation finally completes the step at 814 the nesting level decreases.

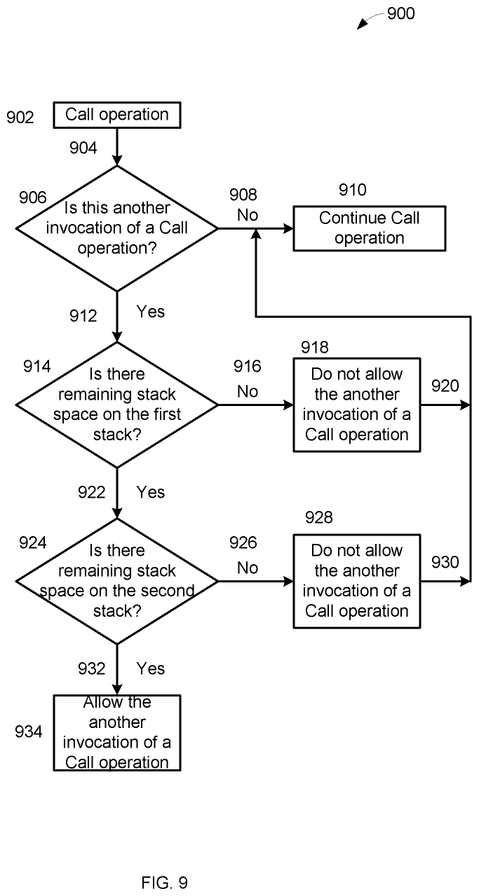

FIG. 9 illustrates, generally at 900, an example flowchart of a call operation, arranged to prevent nested calls when there is insufficient stack space in either the first stack or the second stack. At 902 the call operation 900 begins and proceeds as indicated by 904 to the decision at 906, to determine whether this is another invocation of a call operation? The another invocation of the call operation may occur at any point in time. For example, and without being limited to the particular examples being detailed, in reference to 100 of FIG. 1, the another invocation of the call operation may occur before, or after, or during, any of operations 104, 106, 108, 110, 112, or 114. For example, in reference to 200 of FIG. 2, the another invocation of the call operation may occur before, or after, or during, any of operations 204, 206, 208, 210, 212, 214 or 216. If the answer at 906 is No then the program proceeds as shown at 908 to 910 where the call operation continues. If the answer at 906 is Yes then call operation 900 proceeds as indicated via 912 to the decision at 914, to determine whether there is remaining stack space on the first stack? If the answer at 914 is No then call operation 900 proceeds via 916 to 918 where the another invocation of the call operation is not allowed, then call operation 900 proceeds via 920 to 910 where the prior call operation continues. If the answer at 914 is Yes then call operation 900 proceeds as indicated via 922 to the decision at 924, to determine whether there is remaining stack space on the second stack? If the answer at 924 is No then call operation 900 proceeds via 926 to 928 where the another invocation of the call operation is not allowed, then call operation 900 proceeds via 930 to 910 where the prior call operation 900 continues. If the answer at 924 is Yes then proceed as indicated via 932 to 934 to allow the another invocation of a call operation.

While the operations are shown in FIG. 9 in a sequence, for example, operation at 914 before 924, the operation is not so limited, and for example operation 924 may precede 914 or occur at the same time, or they may overlap in time.

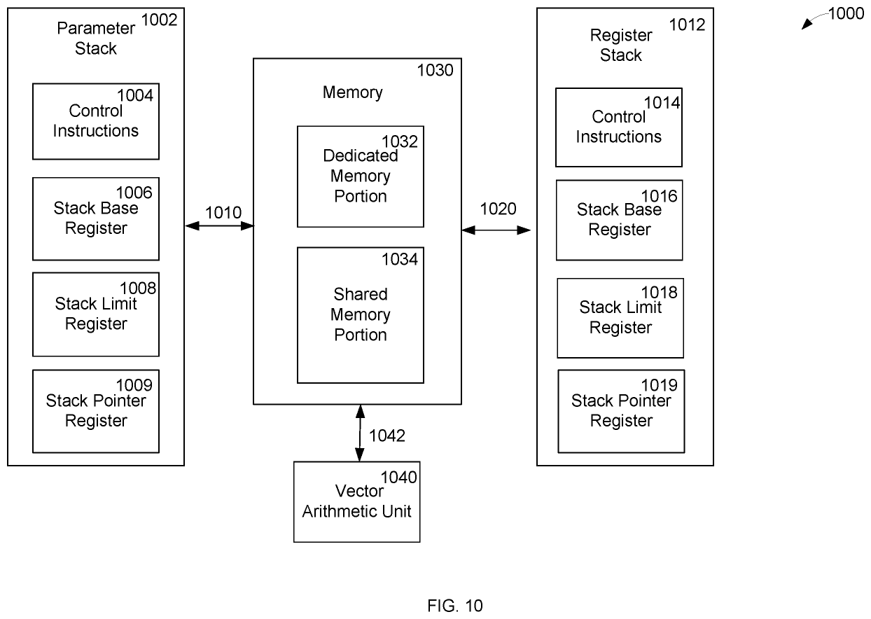

FIG. 10 illustrates, generally at 1000, an example block diagram of a vector processor apparatus. At 1002 is a parameter stack having control instructions 1004, a stack base register 1006, a stack limit register 1008, and a stack pointer register 1009. At 1012 is a register stack having control instructions 1014, a stack base register 1016, a stack limit register 1018, and a stack pointer register 1019. At 1030 is memory having a dedicated memory portion 1032 and a shared memory portion 1034. Memory 1030 is optionally interfaced through 1042 with a vector arithmetic unit 1040. At 1010 is an interface between parameter stack 1002 and memory 1030. At 1020 is an interface between register stack 1012 and memory 1030. While a single stack base register 1006, 1016, and stack limit register 1008, 1018, and stack pointer register 1009, 1019 are described respectively in relation to parameter stack 1002 and register stack 1012, this is not meant to be limiting in any way, and multiple base registers and stack limit registers and stack pointer registers may be provided without exceeding the scope.

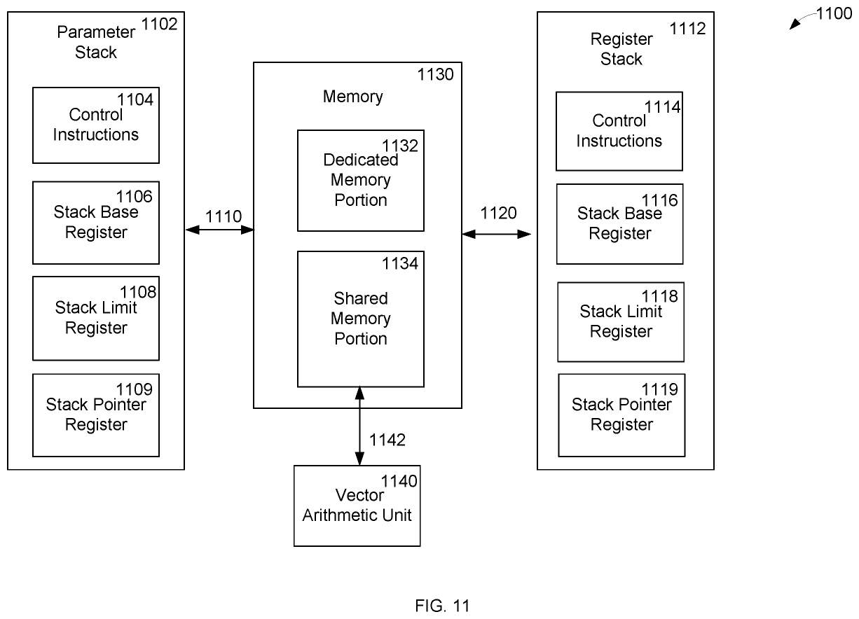

FIG. 11 illustrates, generally at 1100, an example block diagram of a vector processor apparatus where the vector arithmetic unit is configured for communication with the shared memory portion of the memory. At 1102 is a parameter stack having control instructions 1104, a stack base register 1106, a stack limit register 1108, and a stack pointer register 1109. At 1112 is a register stack having control instructions 1114, a stack base register 1116, a stack limit register 1118, and a stack pointer register 1119. At 1130 is a memory having a dedicated memory portion 1132 and a shared memory portion 1134. Shared memory portion 1134 is interfaced through 1142 with Vector Arithmetic Unit 1140. At 1110 is an interface between parameter stack 1102 and memory 1130. At 1120 is an interface between register stack 1112 and memory 1130. While a single stack base register 1106, 1116, and stack limit register 1108, 1118, and stack pointer register 1109, 1119 are described respectively in relation to parameter stack 1102 and register stack 1112, this is not meant to be limiting in any way, and multiple base registers and stack limit registers may be provided without exceeding the scope.

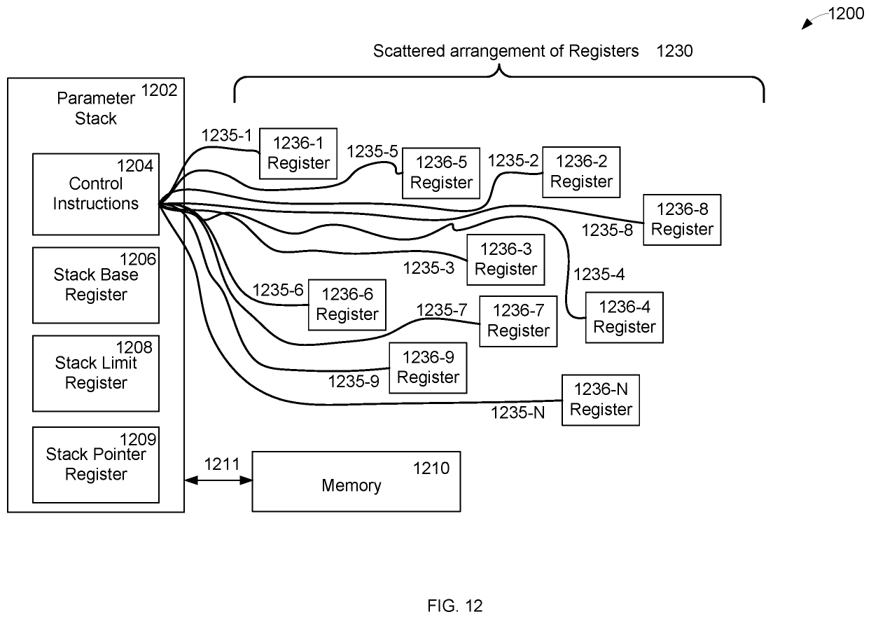

FIG. 12 illustrates, generally at 1200, an example of a scattered arrangement of registers. At 1202 is a parameter stack having control instructions 1204, a base register 1206, a stack limit register 1208, and a stack pointer register 1209. Parameter stack 1202 is interfaced via link 1211 with a memory 1210. Control instructions 1204 show a representative communication via 1235-1, 1235-2, 1235-3, 1235-4, 1235-5, 1235-6, 1235-7, 1235-8, 1235-9, and 1235-N with scattered registers 1236-1, 1236-2, 1236-3, 1236-4, 1236-5, 1236-6, 1236-7, 1236-8, 1236-9, and 1236-N respectively, where N denotes an integer greater than one. The scattered arrangement of registers is denoted as 1230. While a single stack base register 1206, stack limit register 1208, and stack pointer register 1209 are described in relation to parameter stack 1202, this is not meant to be limiting in any way, and multiple base registers and stack limit registers may be provided without exceeding the scope

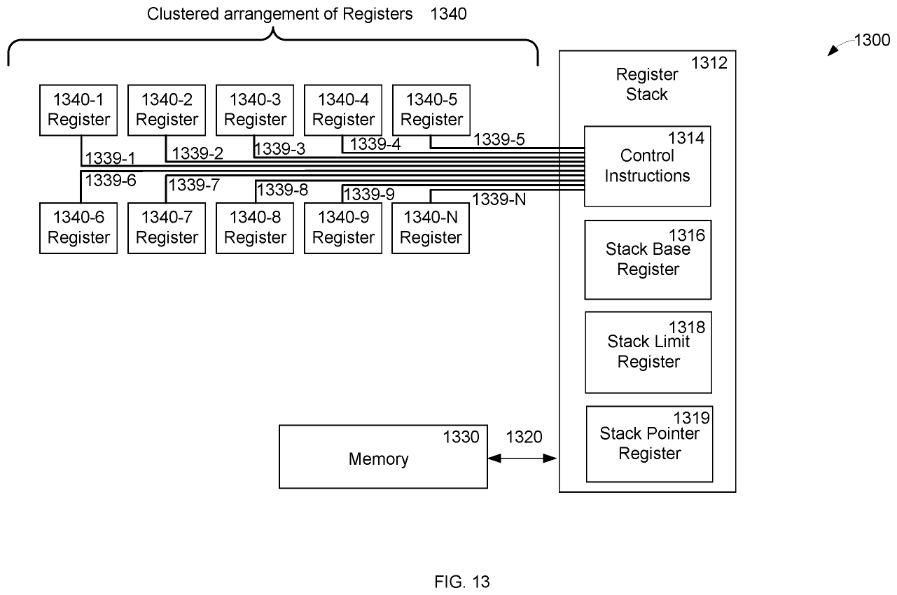

FIG. 13 illustrates, generally at 1300, an example of a clustered arrangement of registers. At 1312 is a register stack having control instructions 1314, a stack base register 1316, a stack limit register 1318, and a stack pointer register 1319. Parameter stack 1312 is interfaced via link 1320 with a memory 1330. Control instructions 1314 show a representative communication via 1339-1, 1339-2, 1339-3, 1339-4, 1339-5, 1339-6, 1339-7, 1339-8, 1339-9, and 1339-N with clustered registers 1340-1, 1340-2, 1340-3, 1340-4, 1340-5, 1340-6, 1340-7, 1340-8, 1340-9, and 1340-N respectively, where N denotes an integer greater than one. The clustered arrangement of registers is denoted as 1340. While a single stack base register 1316, stack limit register 1318, and stack pointer register 1319 are described in relation to register stack 1312, this is not meant to be limiting in any way, and multiple stack base registers and stack limit registers and stack pointer registers may be provided without exceeding the scope.

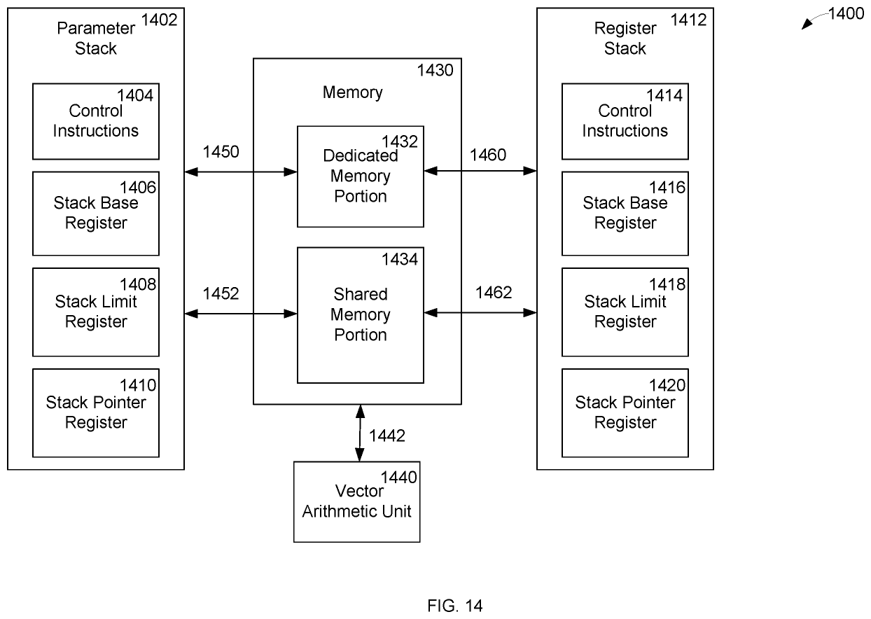

FIG. 14 illustrates, generally at 1400, an example of using the dedicated memory portion or the shared memory portion. At 1402 is a parameter stack having control Instructions 1404, a stack base register 1406, a stack limit register 1408, and a stack pointer register 1410. At 1412 is a register stack having control instructions 1414, a stack base register 1416, a stack limit register 1418, and a stack pointer register 1420. At 1430 is a memory having a dedicated memory portion 1432 and a shared memory portion 1434. Shared memory portion 1434 is optionally interfaced through 1442 with vector arithmetic unit 1440. At 1450 is an interface between parameter stack 1402 and dedicated memory portion 1432. At 1452 is an interface between parameter stack 1402 and shared memory portion 1434. At 1460 is an interface between register stack 1412 and dedicated memory portion 1432. At 1462 is an interface between register stack 1412 and shared memory portion 1434. While a single base register 1406, 1416 and stack limit register 1408, 1418 are described respectively in relation to parameter stack 1402 and register stack 1412, this is not meant to be limiting in any way, and multiple stack base registers and stack limit registers may be provided without exceeding the scope.

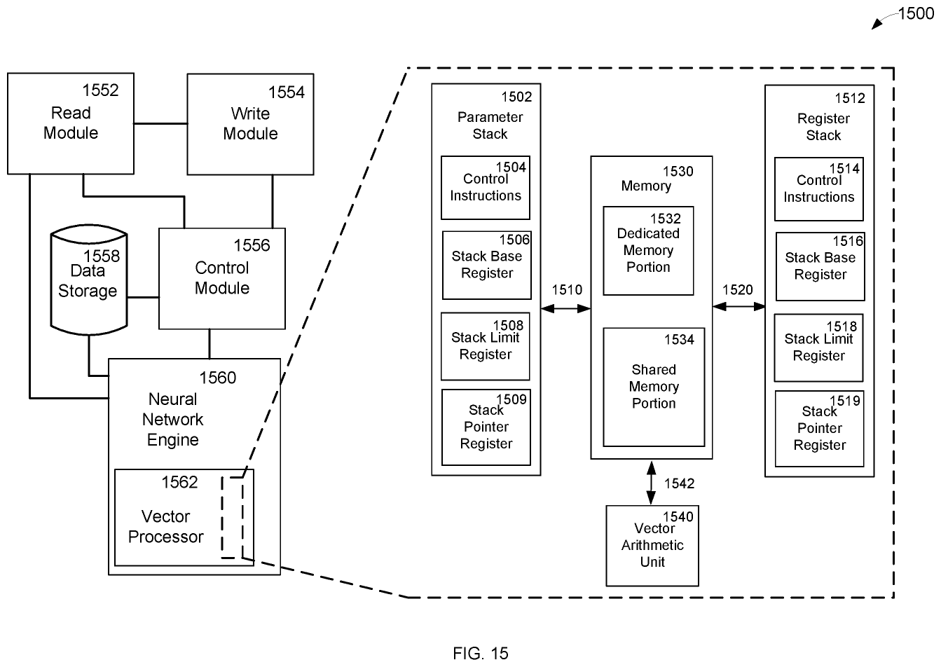

FIG. 15 illustrates, generally at 1500, an example of a flash controller. The flash controller 1500 comprises a read module 1552, a write module 1554 coupled to the read module 1552, and a control module 1556 coupled to the read module 1552, to a data storage 1558 and to the write module 1554. The flash controller has a neural network engine 1560 coupled to the read module 1552, to the data storage 1558 and to the control module 1556. The neural network engine 1560 comprises a vector processor 1562. The vector processor 1562 includes a memory 1530 comprising a dedicated memory portion 1532 and a shared memory portion 1534. The vector processor 1562 includes a parameter stack 1502 having a set of control instructions 1504, a stack base register 1506, a stack limit register 1508, and a stack pointer register 1509, the parameter stack 1502 coupled to the memory 1530 and configured for communication with the memory 1530 via link 1510. The vector processor 1562 includes a register stack 1512 having a set of control instructions 1514, a base register 1516, a stack limit register 1518, and a stack pointer register 1519, the register stack 1512 configured for communication with the memory 1530 via link 1520. A vector arithmetic unit 1540 is coupled to the memory 1530 via link 1542 and configured for communication with the memory 1530. While a single stack base register 1506, 1516 and stack limit register 1508, 1518 are described respectively in relation to parameter stack 1502 and register stack 1512, this is not meant to be limiting in any way, and multiple stack base registers and stack limit registers may be provided without exceeding the scope.

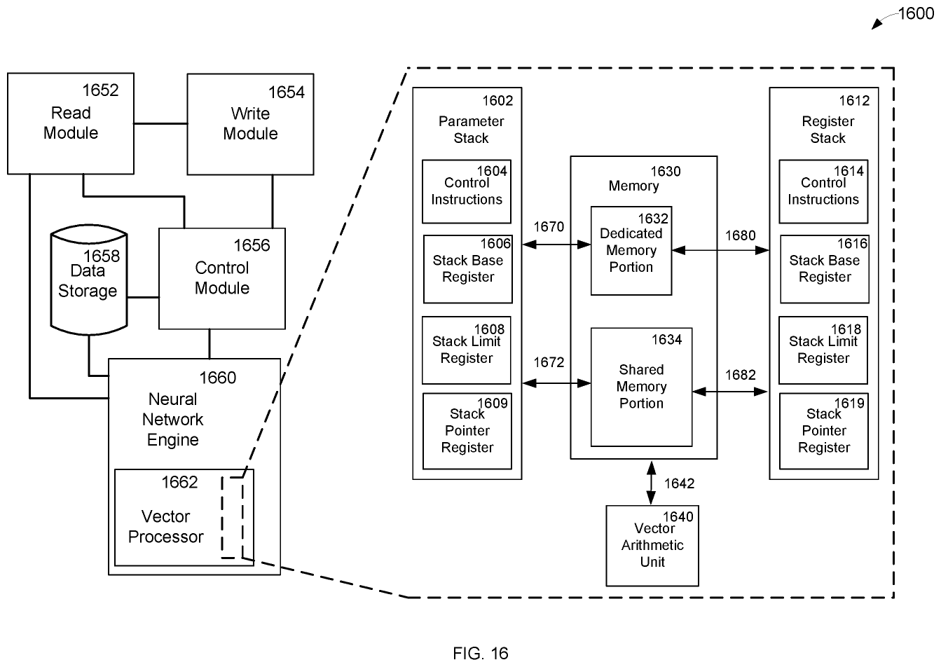

FIG. 16 illustrates, generally at 1600, an example of a flash controller using the dedicated memory portion or the shared memory portion. The flash controller 1600 comprises a read module 1652, a write module 1654 coupled to the read module 1652, and a control module 1656 coupled to the read module 1652, to a data storage 1658 and to the write module 1654. The flash controller has a neural network engine 1660 coupled to the read module 1652, to the data storage 1658 and to the control module 1656. The neural network engine 1660 comprises a vector processor 1662. The vector processor 1662 includes a memory 1630 comprising a dedicated memory portion 1632 and a shared memory portion 1634. The vector processor 1662 includes a parameter stack 1602 having a set of control instructions 1604, a base register 1606, a stack limit register 1608, and a stack pointer register 1609. The parameter stack 1602 is coupled to dedicated memory portion 1632 via link 1670. The parameter stack 1602 is coupled to shared memory portion 1634 via link 1672.

The vector processor 1662 includes a register stack 1612 having a set of control instructions 1614, a stack base register 1616, a stack limit register 1618, and a stack pointer register 1619, the register stack 1612 configured for communication with the dedicated memory portion 1632 via link 1680, and the register stack 1612 is configured for communication with the shared memory portion 1634 via link 1682. A vector arithmetic unit 1640 is coupled to the memory 1630 via link 1642 and configured for communication with the memory 1630. While a single stack base register 1606, 1616, stack limit register 1608, 1618, and stack pointer register 1609, 1619 are described respectively in relation to parameter stack 1602 and register stack 1612, this is not meant to be limiting in any way, and multiple base registers and stack limit registers may be provided without exceeding the scope.

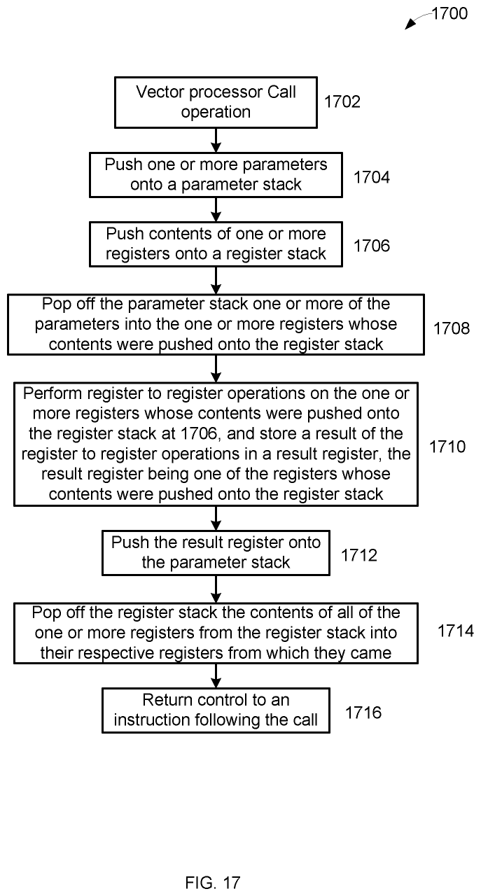

FIG. 17 illustrates, generally at 1700, an example flowchart of a flash controller vector processor call operation. At 1702 the call operation 1700 starts and proceeds to 1704 where one or more parameters are pushed onto a parameter stack. The call operation 1700 then proceeds to 1706 where the contents of one or more registers are pushed onto a register stack. The call operation then proceeds to 1708 where it pops off the parameter stack one or more of the parameters into one or more of the registers whose contents were pushed onto the register stack. The call operation 1700 then proceeds to 1710 where it performs register to register operations on the one or more registers whose contents were pushed onto the register stack at 1706 with a result of the register to register operations being stored in a result register, the result register being one of the registers whose contents were pushed onto the register stack. The call operation 1700 then proceeds to 1712 where it pushes the result register onto the parameter stack. The call operation then proceeds to 1714 where it pops off the register stack the contents of all of the one or more registers from the register stack into their respective registers from which they came. The call operation 1700 then proceeds to 1716 where it returns control to an instruction following the call.

While the operations are shown in FIG. 17 in a sequence, for example, operation at 1704 before 1706, the operation is not so limited, and for example operation 1706 may precede 1704 or occur at the same time, or they may overlap in time.

In FIG. 17 the 1712 operation of pushing the result register onto the parameter stack allows for another operation to simply pop the parameter stack and retrieve the result of the register to register operations, for example from the operation denoted in FIG. 17 at 1710.

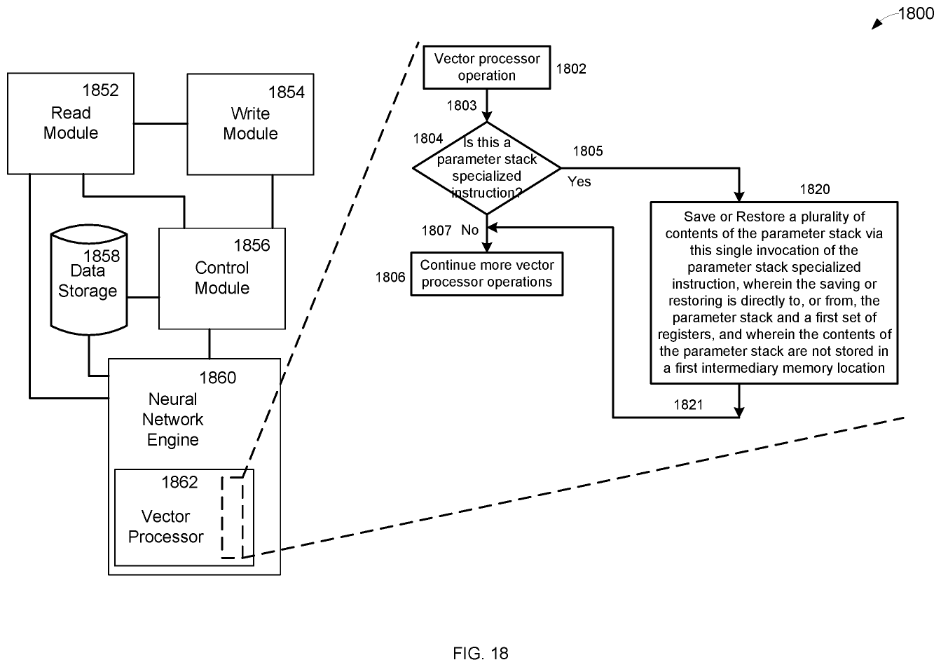

FIG. 18 illustrates, generally at 1800, an example flowchart of a flash controller vector processor including a parameter stack specialized instruction. The flash controller comprises a read module 1852, a write module 1854 coupled to the read module 1852, and a control module 1856 coupled to the read module 1852, to a data storage 1858 and to the write module 1854. The flash controller has a neural network engine 1860 coupled to the read module 1852, to the data storage 1858 and to the control module 1856. The neural network engine 1860 comprises a vector processor 1862. The vector processor 1862 includes a vector processor operation 1802 that proceeds via 1803 to a decision at 1804 to determine if the vector processor operation is a parameter stack specialized instruction. If the answer to 1804 is No then flowchart 1800 proceeds via 1807 to 1806 to continue more vector processor operations. If the answer to 1804 is Yes then flowchart 1800 proceeds via 1805 proceed to 1820 to save or restore a plurality of contents of the parameter stack via this single invocation of the parameter stack specialized instruction, wherein the saving or restoring is directly to, or from, the parameter stack and a first set of registers, and wherein the contents of the parameter stack are not stored in a first intermediary memory location. From 1820 proceed via 1821 to 1806 to continue more vector processor operations.

A parameter stack specialized instruction has encoded within the parameter stack specialized instruction how much stack space it needs to perform a push or a pop of the parameters. That is, a parameter stack specialized instruction performs a plurality of parameter stack operations (push or pop) with a single invocation.

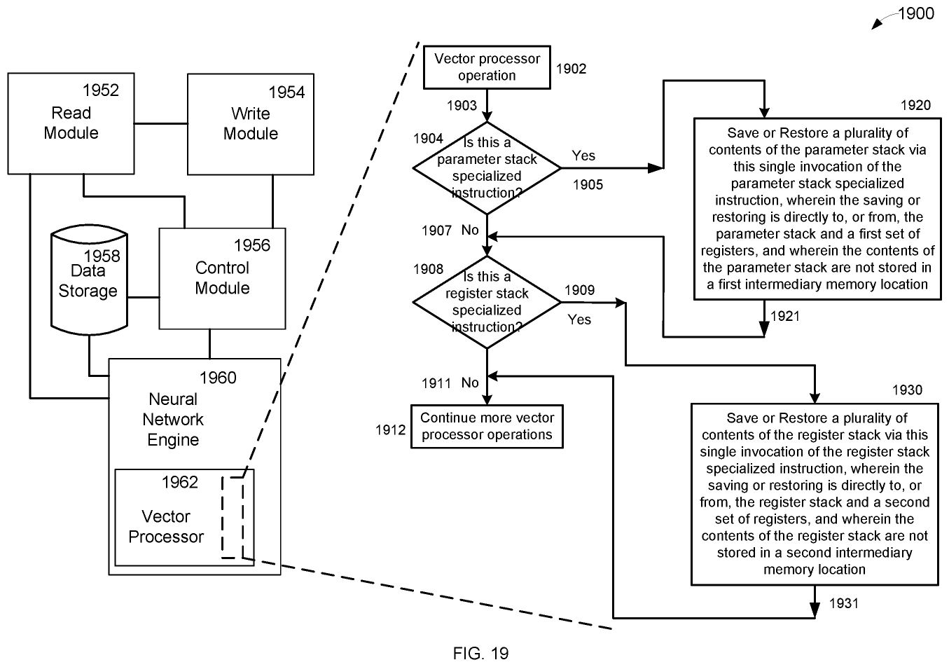

FIG. 19 illustrates, generally at 1900, an example flowchart of a flash controller vector processor including a register stack specialized instruction. The flash controller 1900 comprises a read module 1952, a write module 1954 coupled to the read module 1952, and a control module 1956 coupled to the read module 1952 to a data storage 1958 and to the write module 1954. The flash controller has a neural network engine 1960 coupled to the read module 1952, to the data storage 1958 and to the control module 1956. The neural network engine 1960 comprises a vector processor 1962. The vector processor 1962 includes a vector processor operation 1902 that proceeds via 1903 to a decision at 1904 to determine if the vector processor operation is a parameter stack specialized instruction. If the answer to 1904 is No, then flowchart 1900 proceeds via 1907 to 1908 to determine if the vector processor operation is a register stack specialized instruction. If the answer to 1904 is Yes then flowchart 1900 proceeds via 1905 to 1920 to save or restore a plurality of contents of the parameter stack via this single invocation of the parameter stack specialized instruction, wherein the saving or restoring is directly to, or from, the parameter stack and a first set of registers, and wherein the contents of the parameter stack are not stored in a first intermediary memory location. From 1920 flowchart 1900 proceeds via 1921 to 1908 to determine if the vector processor operation is a register stack specialized instruction. If the answer to 1908 is No then flowchart 1900 proceeds via 1911 to 1912 to continue more vector processor operations. If the answer to 1908 is Yes flowchart 1900 proceeds via 1909 to 1930 to save or restore a plurality of contents of the register stack via this single invocation of the register stack specialized instruction, wherein the saving or restoring is directly to, or from, the register stack and a second set of registers, and wherein the contents of the register stack are not stored in a second intermediary memory location. From 1930 flowchart 1900 proceeds via 1931 to 1912 to continue more vector processor operations.

A register stack specialized instruction has encoded within the register stack specialized instruction how much stack space it needs to perform a push or a pop of the registers. That is, a register stack specialized instruction performs a plurality of register stack operations (push or pop) with a single invocation.

While the operations are shown in FIG. 19 in a sequence, for example, operation at 1904 before 1908, the operation is not so limited, and for example operation 1908 may precede 1904 or occur at the same time, or they may overlap in time.

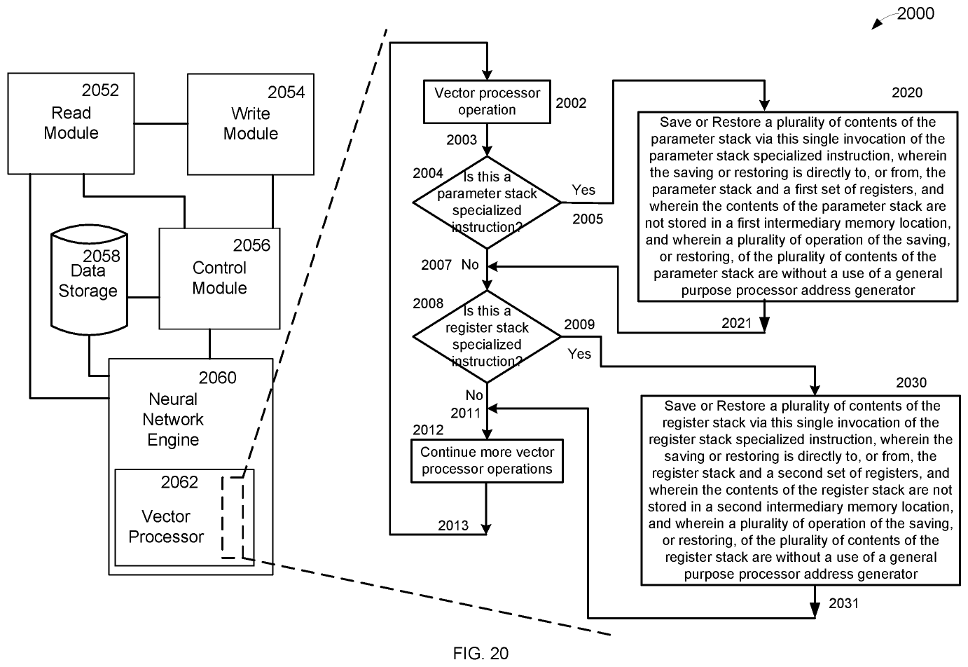

FIG. 20 illustrates, generally at 2000, an example flowchart of a flash controller vector processor without a use of an effective address generator. The flash controller 2000 comprises a read module 2052, a write module 2054 coupled to the read module 2052, and a control module 2056 coupled to the read module 2052, to a data storage 2058 and to the write module 2054. The flash controller has a neural network engine 2060 coupled to the read module 2052, to the data storage 2059 and to the control module 2056. The neural network engine 2060 comprises a vector processor 2062. The vector processor 2062 includes a vector processor operation 2002 that proceeds via 2003 to a decision at 2004 to determine if the vector processor operation is a parameter stack specialized instruction. If the answer to 2004 is No then flowchart 2000 proceeds via 2007 to 2008 to determine if the vector processor operation is a register stack specialized instruction. If the answer to 2004 is Yes then flowchart 2000 proceeds via 2005 to 2020 to save or restore a plurality of contents of the parameter stack via this single invocation of the parameter stack specialized instruction, wherein the saving or restoring is directly to, or from, the parameter stack and a first set of registers, and wherein the contents of the parameter stack are not stored in a first intermediary memory location, and wherein a plurality of operation of the saving, or restoring, of the plurality of contents of the parameter stack are without a use of an effective address generator. From 2020 flowchart 2000 proceeds via 2021 to 2008 to determine if the vector processor operation is a register stack specialized instruction. If the answer to 2008 is No then flowchart 2000 proceeds via 2011 to 2012 to continue more vector processor operations. If the answer to 2008 is Yes then flowchart 2000 proceed via 2009 to 2030 to save or restore a plurality of contents of the register stack via this single invocation of the register stack specialized instruction, wherein the saving or restoring is directly to, or from, the register stack and a second set of registers, and wherein the contents of the register stack are not stored in a second intermediary memory location, and wherein a plurality of operation of the saving, or restoring, of the plurality of contents of the register stack are without a use of an effective address generator. From 2030 flowchart 2000 proceeds via 2031 to 2012 to continue more vector processor operations and via 2013 flowchart 2000 proceeds to 2002 to another vector processor operation.

While the operations are shown in FIG. 20 in a sequence, for example, operation at 2004 before 2008, the operation is not so limited, and for example operation 2008 may precede 2004 or occur at the same time, or they may overlap in time.

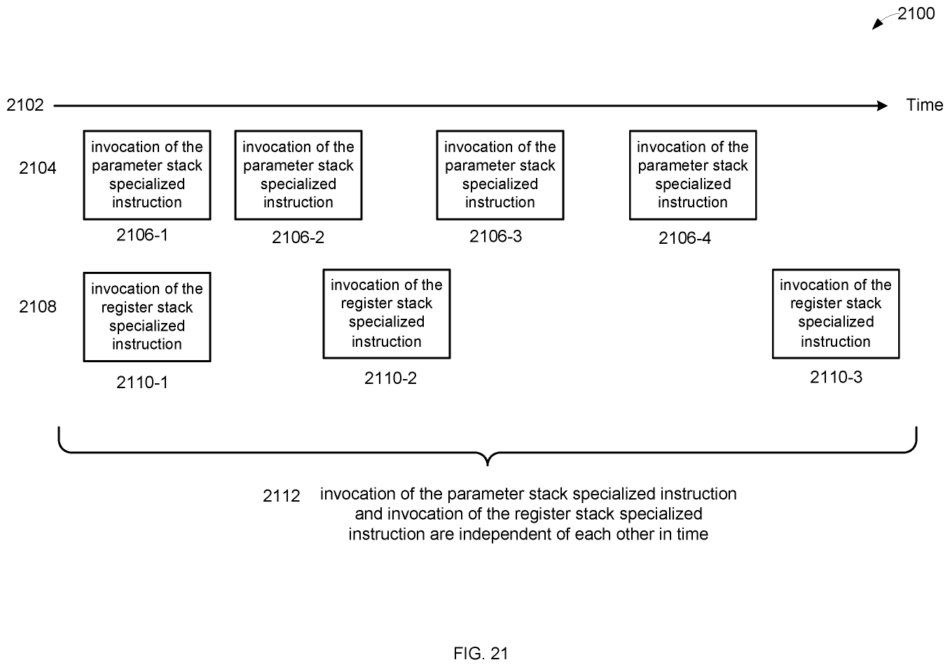

FIG. 21 illustrates, generally at 2100, an example where invocation of the parameter stack specialized instruction and invocation of the register stack specialized instruction are independent of each other in time. At 2102 is a representative timeline denoted Time with the earlier in time arrow at the end proximate to the 2102 marker. The later in time being near the arrow near Time. At 2104 are shown four representative invocations of the parameter stack specialized instruction at 2106-1, 2106-2, 2106-3, and 2106-4. The technique is not so limited and any number of invocations of the parameter stack specialized instruction are possible. At 2108 are shown three representative invocations of the register stack specialized instruction at 2110-1, 2110-2, and 2110-3. The technique is not so limited and any number of invocations of the register stack specialized instruction are possible. As denoted at 2112 invocation of the parameter stack specialized instruction and invocation of the register stack specialized instruction are independent of each other in time, and may overlap in time, or may not overlap in time, without limitation.

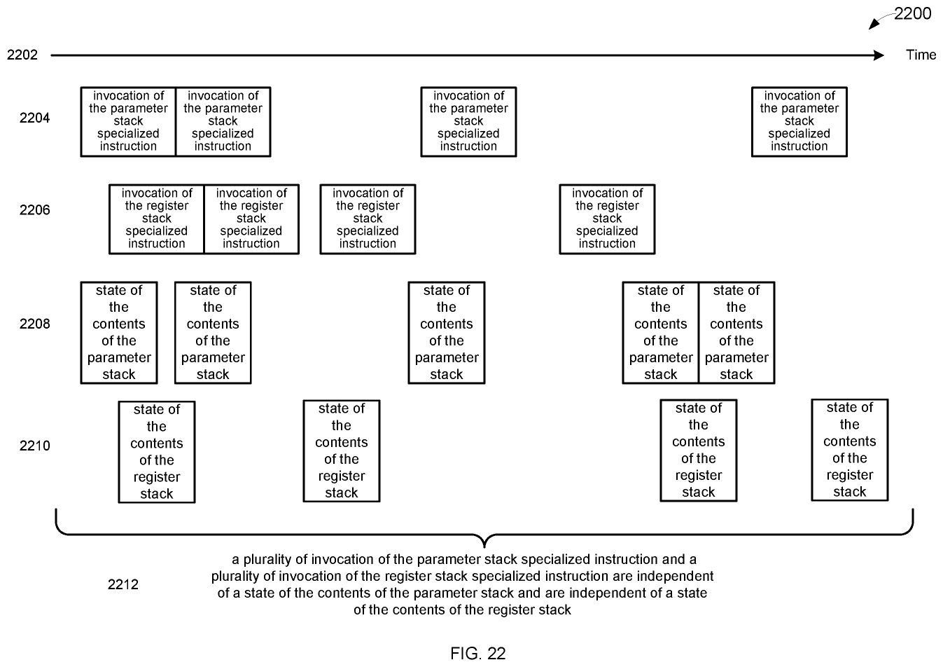

FIG. 22 illustrates, generally at 2200, an example where a plurality of invocations of the parameter stack specialized instruction and a plurality of invocations of the register stack specialized instruction are independent of a state of the contents of the parameter stack and are independent of a state of the contents of the register stack. At 2202 is a representative timeline denoted Time with the earlier in time arrow at the end proximate to the 2202 marker. The later in time being near the arrow near Time. At 2204 are shown four representative invocations of the parameter stack specialized instruction at various times along timeline 2202. At 2206 are shown four representative invocations of the register stack specialized instruction at various times along timeline 2202. At 2208 are shown five representative states of the contents of the parameter stack at various times along timeline 2202. At 2210 are shown four representative states of the contents of the register stack at various times along timeline 2202. Denoted at 2212 a first plurality of invocation of the parameter stack specialized instruction 2204 and a second plurality of invocation of the register stack specialized instruction 2206 are independent of a state of the contents of the parameter stack 2208 and are independent of a state of the contents of the register stack 2210.

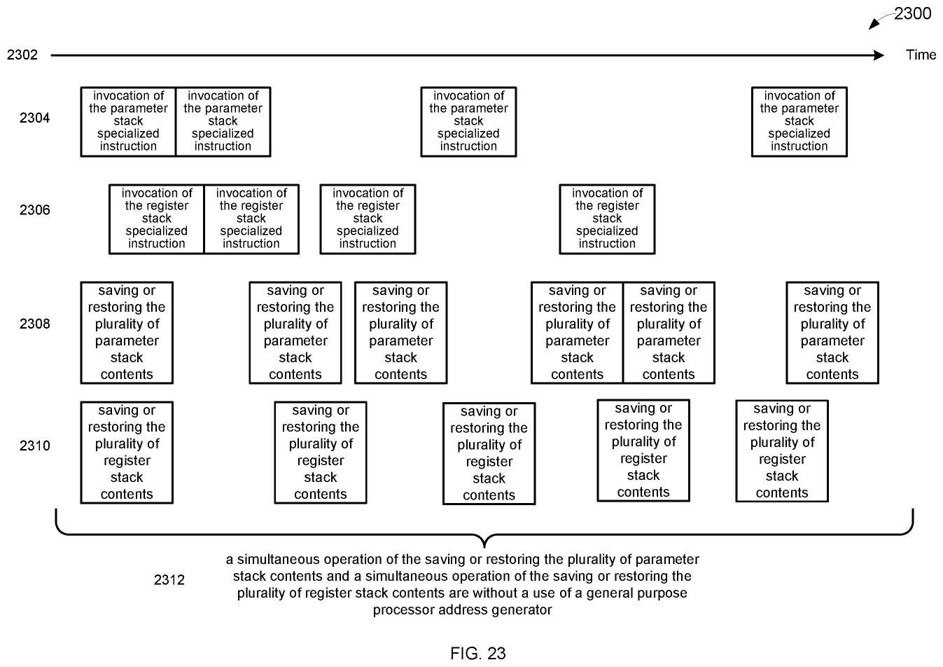

FIG. 23 illustrates, generally at 2300, an example where a simultaneous operation of the saving or restoring the plurality of parameter stack contents and a simultaneous operation of the saving or restoring the plurality of register stack contents are without a use of an effective address generator. At 2302 is a representative timeline denoted Time with the earlier in time arrow at the end proximate to the 2302 marker. The later in time being near the arrow near Time. At 2304 are shown four representative invocations of the parameter stack specialized instruction at various times along timeline 2302. At 2306 are shown four representative invocations of the register stack specialized instruction at various times along timeline 2302. At 2308 are shown six representative saving or restoring the plurality of parameter stack contents. At 2310 are shown five representative saving or restoring the plurality of register stack contents. Denoted at 2312 a simultaneous operation of the saving or restoring the plurality of parameter stack contents and a simultaneous operation of the saving or restoring the plurality of register stack contents are without a use of an effective address generator.

As detailed above and in the claims, a vector processor apparatus is shown where in an example it does not have an effective address generator. The vector processor has a first stack for pushing of parameters, and a second stack for saving and restoring of registers. The first stack and the second stack can be in simultaneous operation.

As illustrated a call (or subroutine) operation can be handled, as well as multiple deep (nested subroutines) or recursive calls can be handled with the techniques disclosed.

In an example, multiple calls (or subroutines) can be handled without the need for an effective address generator.

Also illustrated is the ability to handle both clustered and scattered arrangement of registers.

Additionally, illustrated is the ability of parameter stack and register stack specialized instructions for saving and/or restoring multiple stack memory contents in a single invocation. The specialized instructions can operate substantially simultaneous in time or invocations may be disparate in time. The invocation of the specialized instructions is not dependent on the state of any stack memory contents.

The specialized instructions disclosed herein as noted handle a plurality of stack operations with a single invocation. For example:

SAVE rX pushes r0, r1, . . . , rX to a stack, where X denotes an integer>1
and
RSTR rX pops r0, r1, . . . , rX off a stack, where X denotes an integer>1

An example call operation in pseudo code is:

PUSH reg

| | | | |
|---|---|---|---|
| CALL | ----->> | SAVE reg1 through reg3 −> st_stack | a single instruction |

| POP reg | |
|---|---|
| do work | regs 1, 2, and 3 are now available |
| RSTR sr_stack −> reg 1 through reg 3 | a single instruction |

| | |
|---|---|
| <<----- | RETURN |

For purposes of discussing and understanding the examples, it is to be understood that various terms are used by those knowledgeable in the art to describe techniques and approaches. Furthermore, in the description, for purposes of explanation, numerous specific details are set forth in order to provide a thorough understanding of the examples. It will be evident, however, to one of ordinary skill in the art that the examples may be practiced without these specific details. In some instances, well-known structures and devices are shown in block diagram form, rather than in detail, in order to avoid obscuring the examples. These examples are described in sufficient detail to enable those of ordinary skill in the art to practice the examples, and it is to be understood that other examples may be utilized and that logical, mechanical, and other changes may be made without departing from the scope of the examples.

As used in this description, “one example” or “an example” or similar phrases means that the feature(s) being described are included in at least one example. References to “one example” in this description do not necessarily refer to the same example; however, neither are such examples mutually exclusive. Nor does “one example” imply that there is but a single example. For example, a feature, structure, act, etc. described in “one example” may also be included in other examples. Thus, the invention may include a variety of combinations and/or integrations of the examples described herein.

As used in this description, “substantially” or “substantially equal” or similar phrases are used to indicate that the items are very close or similar. Since two physical entities can never be exactly equal, a phrase such as “substantially equal” is used to indicate that they are for all practical purposes equal.

It is to be understood that in any one or more examples where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2\hat{ }5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

What is claimed is:

1. A method of call operation comprising:
a) pushing one or more parameters onto a first stack;
b) pushing the contents of one or more registers onto a second stack;
c) popping off the first stack one or more of the parameters into one or more of the registers whose contents were pushed onto the second stack;
d) performing register to register operations on the one or more registers whose contents were pushed onto the second stack with a result of the register to register operations being stored in a result register, the result register being one of the one or more registers whose contents were pushed onto the second stack;
e) popping off the second stack the contents of all the one or more registers into their respective registers from which they came; and
f) returning control to an instruction following the call.

2. The method of call operation of claim 1 further comprising between d) and e) pushing the result register onto the first stack.

3. The method of call operation of claim 1 wherein the pushing and popping are directly to, and are directly from, the respective stacks and registers.

4. The method of call operation of claim 1 wherein the register to register operations are performed in a set of parallel operations.

5. The method of call operation of claim 1 wherein the register to register operations are performed in a plurality of serial operations not overlapping in time and in a set of parallel operations.

6. The method of call operation of claim 1 wherein the first stack and the second stack are in substantially simultaneous operation.

7. The method of call operation of claim 1 wherein the register to register operations are performed in a set of one or more serial operations, the one or more serial operations not overlapping in time.

8. The method of call operation of claim 1 wherein at any step a) through f) another invocation of the call operation of claim 1 is performed.

9. The method of call operation of claim 8 wherein the another invocation of the call operation of claim 1 is performed as long as there remains stack space on both the first stack and the second stack.

10. A vector processor apparatus comprising:
a parameter stack, the parameter stack having a respective set of control instructions, a stack base register, a stack limit register, and a stack pointer register, the parameter stack connected to a memory;
a register stack, the register stack having a respective set of control instructions, a stack base register, a stack limit register, and a stack pointer register, the register stack connected to the memory; and
a vector arithmetic unit, the vector arithmetic unit connected to the memory, the memory having a dedicated memory portion and a shared memory portion.

11. The vector processor apparatus of claim 10 wherein the vector arithmetic unit is connected to the shared memory portion of the memory.

12. The vector processor apparatus of claim 10 wherein the parameter stack set of control instructions are to save and restore parameters from a scattered arrangement of registers.

13. The vector processor apparatus of claim 10 wherein the register stack set of control instructions are to save and restore registers from a clustered arrangement of registers.

14. The vector processor apparatus of claim 10 wherein the parameter stack and the register stack can each use the dedicated memory portion or the shared memory portion.

15. A flash controller comprising a read module, a write module coupled to the read module, and a control module coupled to the read module, to a data storage and to the write module, the flash controller comprising:
a neural network engine coupled to the read module, the data storage and the control module, the neural network engine comprising a vector processor, the vector processor including:
a memory comprising a dedicated memory portion and a shared memory portion;
a parameter stack having a respective set of control instructions, a stack base register, a stack limit register, and a stack pointer register, the parameter stack coupled to the memory;
a register stack having a respective set of control instructions, a stack base register, a stack limit register, and a stack pointer register, the register stack coupled to the memory; and
a vector arithmetic unit coupled to the memory.

16. The flash controller of claim 15 wherein the parameter stack and the register stack can each use the dedicated memory portion or the shared memory portion of the memory.

17. The flash controller of claim 15, wherein the vector processor is configured to perform a call operation as:
a) push one or more parameters onto the parameter stack;
b) push the contents of one or more registers onto the register stack;
c) pop off the parameter stack one or more of the parameters into the one or more registers whose contents were pushed onto the register stack;
d) perform register to register operations on the one or more registers whose contents were pushed onto the register stack, and store a result of the register to register operations in a result register, the result register being one of the registers whose contents were pushed onto the register stack;
e) push the contents of the result register onto the parameter stack;
f) pop off the register stack the contents of all the one or more registers from the register stack into their respective registers from which they came; and
g) return control to an instruction following the call.

18. The flash controller of claim 15 wherein:
the vector processor includes a parameter stack specialized instruction, the parameter stack specialized instruction to save or restore a plurality of contents of the parameter stack via a single invocation of the parameter stack specialized instruction, wherein the save or restore is directly to, or from, the parameter stack and a first set of registers.

19. The flash controller of claim 18 wherein:
the vector processor including a register stack specialized instruction, the register stack specialized instruction for saving or restoring a plurality of contents of the register stack via a single invocation of the register stack specialized instruction, wherein the save or restore is directly to, or from, the register stack and a second set of registers.

20. The flash controller of claim 19 wherein a plurality of operation of the save, or restore, of the plurality of contents of the parameter stack and a plurality operation of the save, or restore, of the plurality of contents of the register stack are without a use of an effective address generator.

21. The flash controller of claim 19 wherein invocation of the parameter stack specialized instruction and invocation of the register stack specialized instruction are independent of each other in time.

22. The flash controller of claim 19 wherein a first plurality of invocations of the parameter stack specialized instruction and a second plurality of invocations of the register stack specialized instruction are independent of a state of the contents of the parameter stack and are independent of a state of the contents of the register stack.

23. The flash controller of claim 22 wherein a simultaneous operation of the saving or restoring the plurality of parameter stack contents and a simultaneous operation of the saving or restoring the plurality of register stack contents are without a use of an effective address generator.
